(19) United States
(12) Patent Application Publication
(10) Pub. No.: US 2026/0252097 A1
(43) Pub. Date: Aug. 27, 2026

(54) MODELING AN AREA OF A ROBOT WITH CIRCLES AND GENERATING A PATH USING THE SAME

(71) Applicants: Hyundai Motor Company, Seoul (KR); Kia Corporation, Seoul (KR)

(72) Inventor: Hwanhee Lee, Hwaseong-si (KR)

(21) Appl. No.: 19/324,633

(22) Filed: Sep. 10, 2025

(30) Foreign Application Priority Data
Feb. 21, 2025 (KR) 10-2025-0023033

(51) Int. Cl. G05D 1/644; G05D 101/10

(52) U.S. Cl. CPC G05D 1/644; G05D 2101/10

(57) ABSTRACT

In an embodiment, an area of a robot is modeled with multiple circles, and a path is generated using the same. The robot may include a robot driver including at least one wheel and, and a corner module may be configured to connect each wheel to the robot through a joint. Modeling the area of the robot with the multiple circles may include determining status information of the corner module by a sensor device; receiving the status information of the corner module by a controller; determining a robot boundary based on specifications of the robot and the status information of the corner module by the controller; and performing modeling with the multiple circles covering the robot boundary by the controller.

### CROSS-REFERENCE TO RELATED APPLICATIONS

This application claims the benefit of and priority to Korean Patent Application No. 10-2025-0023033, filed with the Korean Intellectual Property Office on Feb. 21, 2025, the entire contents of which are incorporated herein by reference.

### TECHNICAL FIELD

The present disclosure relates to a system and a method for generating a path for a robot, and more particularly, to a method for modeling an area of a robot with multiple circles, and a system and a method for generating a path using the same.

### BACKGROUND

Recently, utilization of mobile robots such as indoor or outdoor delivery robots, service robots, and patrol robots has been increasing. Most of such mobile robots are performing their missions based on autonomous driving technology. In order for a mobile robot to safely autonomously navigate from its current position to its destination, technology for determining potential collisions between the robot and obstacles is crucial.

A shape of a robot may be represented in various forms, such as a circle, a quadrangle, or a variable-shaped quadrangle, and a method of determining collisions with obstacles may vary depending on the shape used to represent the robot.

In one example, if a robot is represented as a circle, grids occupied by an obstacle are expanded by a radius of the circle, and a collision between the robot and the obstacle may be determined by checking whether a center of the robot is positioned within the expanded occupied grids

In another example, if the robot is represented as a square, grids occupied by the obstacle are expanded by half a length of a side of the square, and a collision between the robot and the obstacle may be determined by checking whether the center of the robot is positioned within the expanded occupied grids. However, in this case, whether the robot collides with the obstacle may be incorrectly determined depending on a posture of the robot. For example, when an extended direction from the obstacle coincides with a diagonal direction of the robot, the center of the robot is positioned outside the extended occupied grids, but a vertex of the robot may actually collide with the obstacle.

In order to prevent such incorrect determination, the collision between the robot and the obstacle may be determined by expanding the grids occupied by the obstacle by half a diagonal length of the square representing the robot and checking whether the center of the robot is positioned within the expanded occupied grids. However, in this case, the robot may erroneously determine that the robot cannot pass through a narrow passage that the robot is actually capable of traversing through. Accordingly, if the robot is expressed as the square, collision determination is required not only for the center of the square but also for a vertex thereof.

However, if the robot is represented as the square, its size may be enlarged substantially beyond the dimensions desirable for the collision determination, and as the robot's size increases, a computational load associated with the collision determination may increase exponentially.

In addition, the robot with four wheels may be expressed as a rectangle rather than a square, and in this case, it is not easy to apply a collision determination method that is applicable to the robot expressed as the circle or the square.

The above information disclosed in this Background section is only for enhancement of understanding of the background of the disclosure, and therefore, it may contain information that does not form the prior art that is already known in this country to a person of ordinary skill in the art.

### SUMMARY

An embodiment of the present disclosure attempts to provide a method for modeling an area of a robot with multiple circles that is consistently applicable regardless of a size and a shape of the robot by representing the robot as a rectangular area and modeling the rectangular area of the robot into a certain number of circles.

In addition, another embodiment of the present disclosure attempts to provide a path generation system and a path generation method capable of efficiently checking a collision by modeling an area of a robot with a certain number of circles, ensuring a consistent computational load.

An embodiment of the present disclosure provides a method of modeling an area of a robot with multiple circles.

The robot may include a robot driver including at least one wheel and configured to drive the robot, and a corner module may be configured to connect each wheel to the robot through a joint.

The method may include determining status information of the corner module by a sensor device, receiving the status information of the corner module by a controller, determining a robot boundary based on specifications of the robot and the status information of the corner module by the controller, and performing modeling with the multiple circles covering the robot boundary by the controller.

The robot boundary may have a smallest rectangle that encompasses the area of the robot in which the robot is locatable.

The performing modeling with the multiple circles covering the robot boundary may include performing modeling with multiple small circles, each of which is positioned at a corner and has a first radius, and performing modeling with multiple large circles, each of which is positioned at a central portion and has a second radius that is greater than the first radius.

A number of small circles may be four, and a number of large circles may be three.

The performing modeling with the multiple small circles may include determining parameters of four small circles, parameters of each small circle may include center coordinates of each small circle and a first radius, and the parameters of each small circle may be determined such that each small circle passes through a vertex close to the corresponding small circle and a point that is close to the vertex among points that divide a short side of the robot boundary including the vertex into three equal or substantially equal portions.

The performing modeling with multiple large circles may include determining parameters of three large circles, parameters of each large circle may include center coordinates of each large circle and a second radius, the three large circles may include a large circle at a center, a center of the large circle at the center may coincide with a center of the robot boundary, and the second radius may be determined such that the large circle at the center is tangent to a line parallel to a long side of the robot boundary and to which the small circle is tangent.

A center of each of the remaining large circles may be determined to be tangent to two lines parallel to long and short sides of the robot boundary and to which a small circle is tangent.

The status information of the corner module may include whether the corner module is a variable corner module, a steering angle of the corner module, and/or a longitudinal distance from a center of the wheel to the corresponding joint.

The robot boundary may be determined by using a relative position of the joint to a center of the robot, a relative position of the center of the wheel to the corresponding joint, a radius of the wheel, and the steering angle of the corner module, based at least in part on the status information of the corner module indicates that the corner module is not the variable corner module.

The robot boundary may be determined by using a relative position of the joint to a center of the robot, a relative position of the center of the wheel to the corresponding joint, a radius of the wheel, the steering angle of the corner module, and the longitudinal distance from the center of the wheel to the corresponding joint, based at least in part on the status information of the corner module indicates that the corner module is the variable corner module.

Another embodiment of the present disclosure provides a path generation system for a robot. The system may include a sensor device configured to determine sensor data within a field of view and determine status information of the corner module, and a controller configured to receive the sensor data and the status information of the corner module from the sensor device, generate a path from a current position of the robot to a destination, and control movement of the robot according to the generated path, the controller may be configured to create a cost map for surroundings of the robot based on a grid map and the sensor data received from the sensor device, model an area of the robot in which the robot is locatable with a robot area modeling, generate a feasible path from the current position of the robot to the destination while or otherwise in accord with avoiding an obstacle by using the cost map and the robot area modeling, and to control driving and steering of the robot to allow it to follow the generated path. The robot area modeling may include multiple circles covering a robot boundary, and the robot boundary may have a smallest rectangle that encompasses the area of the robot in which the robot is locatable. As used herein, the term “surroundings” is intended to refer to an area or space adjacent to or otherwise proximate to, for example, the robot, and the surroundings may wholly or substantially surround the robot.

The controller, when modeling with the robot area modeling, may be configured to determine the robot boundary based on specifications of the robot and the status information of the corner module, and model the robot boundary with four small circles, each of which is positioned at a corner and has a first radius and three large circles, each of which is positioned at a central portion and has a second radius that is greater than the first radius.

The controller, when modeling with the four small circles, may be configured to determine parameters of the four small circles, the parameters of each small circle may include center coordinates of each small circle and a first radius thereof, and the parameters of each small circle may be determined such that each small circle passes through a vertex close to the corresponding small circle and a point that is close to the vertex among points that divide a short side of the robot boundary including the vertex into three equal or substantially equal portions.

The controller, when modeling with the three large circles, may be configured to determine parameters of the three large circles, the parameters of each large circle may include center coordinates of each large circle and a second radius, the three large circles may include a large circle at a center, a center of the large circle at the center may coincide with a center of the robot boundary, and the second radius may be determined such that the large circle at the center is tangent to a line parallel to a long side of the robot boundary and to which the small circle is tangent.

The controller may be configured to determine a center of each of the remaining large circles to be tangent to two lines parallel to long and short sides of the robot boundary and to which a small circle is tangent.

The status information of the corner module may include whether the corner module is a variable corner module, a steering angle of the corner module, and/or a longitudinal distance from a center of the wheel to the corresponding joint.

Another embodiment of the present disclosure provides a path generation method for a robot. The method may include determining sensor data and status information of the corner module within a field of view by a sensor device, receiving the sensor data and the status information of the corner module by a controller, creating a cost map for surroundings of the robot based on a grid map and the sensor data received from the sensor device by the controller, modeling an area of the robot in which the robot is locatable with a robot area modeling by the controller, generating a feasible path from a current position of the robot to a destination while or otherwise in accord with avoiding an obstacle by using the cost map and the robot area modeling by the controller, and controlling driving and steering of the robot to allow it to follow the generated path by the controller,

The robot area modeling may include multiple circles covering a robot boundary, and the robot boundary may have a smallest rectangle that encompasses the area of the robot in which the robot is locatable.

The modeling with a robot area modeling may include determining the robot boundary based on specifications of the robot and the status information of the corner module; modeling the robot boundary with four small circles, each of which is positioned at a corner and has a first radius; and modeling the robot boundary with three large circles, each of which is positioned at a central portion and has a second radius that is greater than the first radius.

The modeling with four small circles may include determining parameters of the four small circles, the parameters of each small circle may include center coordinates of each small circle and a first radius, and the parameters of each small circle may be determined such that each small circle passes through a vertex close to the corresponding small circle and a point that is close to the vertex among points that divide a short side of the robot boundary including the vertex into three equal or substantially equal portions.

The modeling with three large circles may include determining parameters of the three large circles, the parameters of each large circle may include center coordinates of each large circle and a second radius, the three large circles may include a large circle at a center, a center of the large circle at the center may coincide with a center of the robot boundary, and the second radius may be determined such that the large circle at the center is tangent to a line parallel to a long side of the robot boundary and to which the small circle is tangent.

A center of each of the remaining large circles may be determined to be tangent to two lines parallel to long and short sides of the robot boundary and to which a small circle is tangent.

The status information of the corner module may include whether the corner module is a variable corner module, a steering angle of the corner module, and/or a longitudinal distance from a center of the wheel to the corresponding joint.

According to an embodiment of the present disclosure, the method of modeling the area of the robot may be consistently applicable regardless of the size and the shape of the robot by representing the robot as the rectangular area and modeling the rectangular area of the robot with the certain number of circles.

Additionally, the computational load that is desirable for path generation may be reduced by performing modeling with a minimum number of circles required for accurate collision determination.

Further, effects that can be obtained or expected from embodiments of the present disclosure are directly or suggestively described in the following detailed description. That is, various effects expected from embodiments of the present disclosure will be described in the following detailed description.

### BRIEF DESCRIPTION OF THE DRAWINGS

Embodiments herein may be better understood by reference to the following description in connection with the accompanying drawings in which like reference numerals refer to identical or functionally similar elements.

FIG. 1 illustrates a block diagram of a path generation system using a robot area modeled with multiple circles according to an embodiment of the present disclosure.

FIG. 2 schematically illustrates an example of an occupancy grid map.

FIG. 3 schematically illustrates an example of a cost map.

FIG. 4A illustrates a schematic diagram showing an outline of a robot with a fixed shape (or a robot with wheels in a default position).

FIG. 4B illustrates a schematic diagram showing an outline of a robot with wheels in an extended position.

FIG. 5 illustrates a flowchart showing a path generation method according to another embodiment of the present disclosure.

FIG. 6 illustrates a detailed flowchart of an operation S130 in FIG. 5.

FIG. 7 illustrates a schematic diagram for describing a method for modeling a rectangular area of a robot with a certain number of circles.

FIG. 8 illustrates a schematic diagram of a method of determining a collision using a robot area modeled with a certain number of circles, showing a case where a robot does not collide with an obstacle.

FIG. 9 illustrates a schematic diagram of a method for determining a collision using a robot area modeled with a certain number of circles, showing a case where a robot collides with an obstacle.

It is to be understood that the drawings referenced above are not necessarily drawn to scale, but rather present a somewhat simplified representation of various preferred features illustrating the basic principles of the present disclosure. Certain design features of the present disclosure, including, e.g., particular dimensions, orientations, positions, and shapes will be determined in part by the particular intended application and usage environment.

### DETAILED DESCRIPTION OF ILLUSTRATIVE EMBODIMENTS

The terminologies used herein are for the purpose of describing particular only, and is not intended to limit the present disclosure. As used herein, singular forms are intended to include plural forms as well, unless explicitly stated otherwise in the context. The terms “comprise” and/or “comprising,” when used herein, specify presence of the recited features, integers, steps, operations, acts, elements and/or components, but it will also be understood that this does not exclude the presence or addition of one or more of other features, integers, steps, acts, elements, components, and/or groups thereof. As used herein, the term “and/or” includes any one or all combinations of the associated listed items.

In this specification, the term ‘robot’ and other similar terms include a land-based robot, such as a passenger car, including a sport utility vehicle (SUV), a bus, a truck, and various commercial vehicles; a marine robot, including various boats and ships; and an aerial robot, including an aircraft and a drone, and encompasses all objects capable of movement powered by a source of energy. In addition, in this specification, the term ‘robot’ and other similar terms are understood to include a hybrid-powered robot, an electric-powered robot, a plug-in hybrid-powered robot, a hydrogen-powered robot, and a robot utilizing other alternative fuels (e.g., fuels derived from resources other than petroleum). As mentioned in this specification, the hybrid-powered robot refers to a robot that has two or more power sources, such as a gasoline-powered and an electric-powered system. A robot according to an embodiment of the present disclosure includes not only a partially autonomous driving robot but also a fully autonomous or automatically driving robot.

Additionally, it is understood that one or more of the following methods or embodiments thereof may be executed by at least one controller. The term ‘controller’ may refer to a hardware device that includes a memory and a processor.

The memory is configured to store program instructions, and the processor is specifically programmed to execute the program instructions to perform one or more processes described in further detail below. The controller, as described herein, may control operations of units, modules, components, devices, or similar elements. Furthermore, it is understood that the following methods are able to be executed by a device that includes a controller along with one or more other components, as recognized by those skilled in the art.

Additionally, the controller of the present disclosure may be implemented as a non-transitory computer-readable recording medium containing executable program instructions executed by a processor. Examples of the computer-readable recording media include, but are not limited to, a ROM, a RAM, a compact disc (CD) ROM, a magnetic tape, a floppy disk, a flash drive, a smart card, and an optical data storage device. The computer-readable recording medium may also be distributed across a computer network so that program instructions can be stored and executed in a distributed manner, such as on a telematics server or a controller area network (CAN).

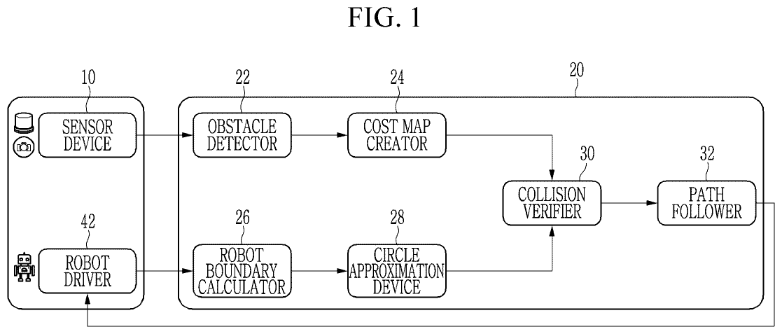

FIG. 1 illustrates a block diagram of a path generation system using a robot area modeled with multiple circles according to an embodiment of the present disclosure.

As illustrated in FIG. 1, the path generation system using an area of a robot 40 modeled with multiple circles according to an embodiment of the present disclosure may include a sensor device 10, a controller 20, and the robot 40.

The sensor device 10 may be mounted on the robot 40, and may include any sensor capable of determining an obstacle within a field of view, such as a lidar, a camera, or a radar. Herein, the term ‘obstacle’ and similar terms may refer to objects that obstruct movement of the robot 40 or prevent the robot 40 from passing through, such as a building, a wall, or a person. The term ‘obstacle’ and similar terms may also refer to the object that occupies a physical space, and may include the object positioned within a height range of the robot 40. The sensor device 10 may be connected to transmit data to the controller 20 and transmit sensor data determined within the field of view to the controller 20.

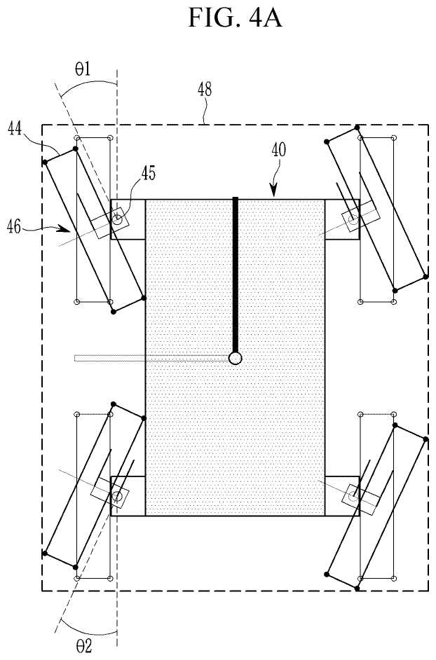

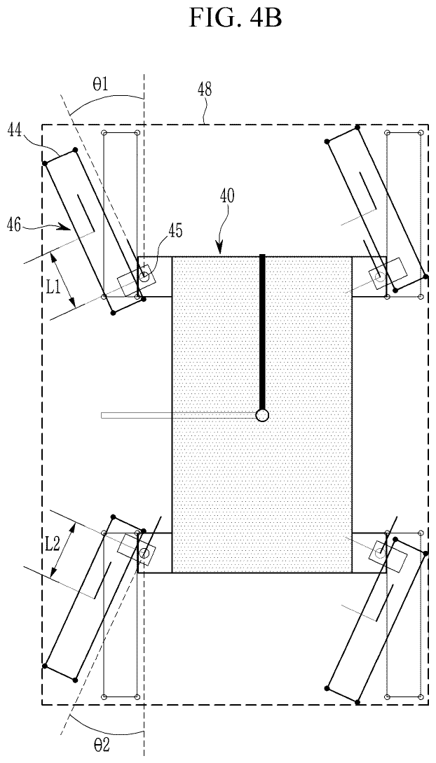

Herein, the robot 40 may include at least an energy storage device and a robot driver 42, and the robot driver 42 may receive a power from the energy storage device under control of the controller 20 to drive the robot 40 to follow a path. The robot driver 42 may include, but is not limited to, at least one wheel and at least one drive motor connected to the wheel to rotate the wheel. The robot driver 42 may further include a corner module 46 that includes a steering device for steering the robot 40 and a suspension device that connects the robot driver 42 to a main body of the robot 40 to flexibly support the robot 40. In one example, the corner module 46 may serve as a variable corner module 46 that connects the wheel to the robot 40 in such a way that a relative position between a center of the wheel and a center of the robot 40 is capable of changing. The variable corner module 46 may connect the wheel to the main body of the robot 40 via a joint 45, may enable the wheel to rotate around a vertical axis of the joint 45 for steering the robot 40, and may adjust a distance in a longitudinal direction of the wheel and the relative height from the center of the wheel to the joint 45 (see FIGS. 4A and 4B).

The sensor device 10 may also determine status information of the corner module 46 and transmit the determined status information to the controller 20. The status information of the corner module 46 may include whether the corner module 46 serves as the variable corner module 46, an angle at which the wheel has rotated about the vertical axis relative to the longitudinal direction of the robot 40, i.e., steering angles θ1 and θ2 of the corner module 46, and/or longitudinal distances L1 and L2 from the center of each wheel to the corresponding joint (see FIGS. 4A and 4B). The steering angles θ1 and θ2 of the corner module 46 may include a steering angle θ1 of a front wheel and a steering angle θ2 of a rear wheel, and the longitudinal distances L1 and L2 from the center of each wheel to the corresponding joint may include a front wheel longitudinal distance L1 from a center of the front wheel to a front wheel joint and a rear wheel longitudinal distance L2 from a center of the rear wheel to a rear wheel joint.

The controller 20 may receive the sensor data and the status information of the corner module 46 from the sensor device 10, model an area of the robot 40 with a predetermined number of circles based on the status information of the corner module 46 and specifications of the robot 40, generate a path for autonomous driving of the robot 40 based on the modeled area of the robot 40 and the sensor data, and control the autonomous driving of the robot 40 according to the generated path. To this end, the controller 20 may be implemented as one or more processors operated by a set program, and the set program may be programmed to perform each operation of a path generation method according to an embodiment of the present disclosure. The set program may be stored in advance in the memory within the controller 20. The controller 20 may include an obstacle detector 22, a cost map creator 24, a robot boundary calculator 26, a circle approximation device 28, a collision verifier 30, and a path follower 32.

The obstacle detector 22 may determine the obstacle based on the sensor data received from the sensor device 10, and may transmit information on the determined obstacle to the cost map creator 24. The information about the obstacle may include an existence, a type, a position, etc. of the obstacle. The obstacle detector 22 may store an obstacle determination logic for determining the obstacle from the sensor data, and the obstacle determination logic may be point cloud and image-based, deep learning-based, sensor fusion-based, etc., and is not particularly limited, and any appropriate obstacle determination logic known to those skilled in the art may be used.

A grid map may be stored in the cost map creator 24, and the cost map creator 24 may create an occupancy grid map 50 based on the grid map and the obstacle information transmitted from the obstacle detector 22. In addition, the cost map creator 24 may be configured to create a cost map 54 for surroundings of the robot 40 based on the occupancy grid map 50 and the obstacle information.

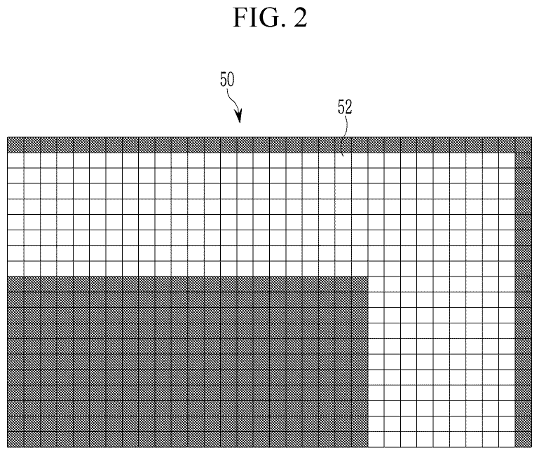

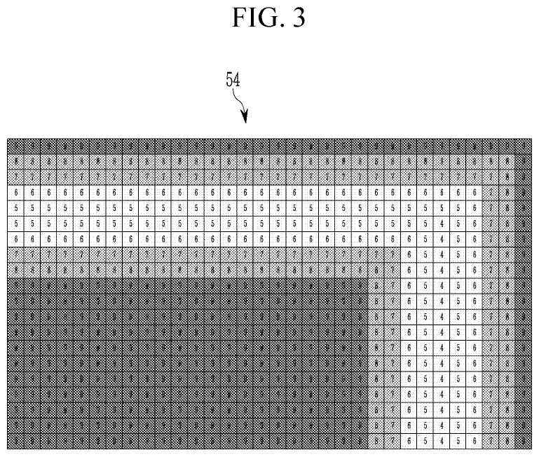

FIG. 2 schematically illustrates an example of the occupancy grid map, and FIG. 3 schematically illustrates an example of the cost map. The grid map may indicate a map that divides a physical space, such as a ground or floor, on which the robot 40 is capable of driving, into a plurality of grids 52 of the same size, the occupancy grid map 50 may indicate a map that displays (for example, in dark gray), records, or stores occupancy of the obstacle on the grid map based on the obstacle information, as illustrated in FIG. 2, and the cost map 54 may indicate a map that displays, records, or stores a cost required for the robot 40 to pass through the corresponding grid 52, as illustrated in FIG. 3.

For example, as shown in FIG. 3, the highest cost of 9 is assigned to the grid 52 occupied by the obstacle, and the cost assigned to each grid 52 may be linearly reduced as a distance from an occupied area increases. Alternatively, a value of 9 may be assigned to the grid 52 occupied by the obstacle, and a cost assigned to each grid 52 may decrease non-linearly as the distance from the occupied area increases. Further alternatively, a cost may be assigned to the grid 52 based on the type of obstacle, heat map information, etc., as well as the distance to the obstacle. However, a method of allocating a cost to each grid 52 of the cost map 54 is not limited to the illustrated method, and a person skilled in the art may adopt any cost allocation method deemed appropriate.

The robot boundary calculator 26 may be configured to represent a smallest rectangle that encompasses the area of the robot 40 in which components of the robot 40 may exist as a robot boundary 48. More specifically, the robot boundary calculator 26 may determine the smallest rectangle that encompasses the area of the robot 40 where the components of the robot 40 may exist as the robot boundary 48 based on the specifications of the robot 40 stored in the memory and the status information of the corner module 46 transmitted from the sensor device 10. Herein, the specifications of the robot 40 may include, but are not limited to, relative positions of the joints 45 with respect to the center of the robot 40, relative positions of centers of the corresponding wheels 44 with respect to each joint 45, a radius of each wheel 44, a height of the robot 40, etc., and the status information of the corner module 46 may include, but are not limited to, whether the corner module 46 serves as the variable corner module 46, the steering angles θ1 and θ2 of the corner module 46, and/or the longitudinal distances L1 and L2 from the center of the wheel to the joint.

FIG. 4A illustrates a schematic diagram showing an outline of a robot with a fixed shape (or a robot with wheels in a default position), and FIG. 4B illustrates a schematic diagram showing an outline of a robot with wheels in an extended position.

In one example, as illustrated in FIG. 4A, if the robot 40 has the fixed shape (the corner module 46 does not serve as the variable corner module 46) or the robot 40 has the variable corner module 46 but the wheels 44 are in the default positions, the robot boundary calculator 26 may determine a rectangle as the robot boundary 48, which sets a maximum distance of positions at which the wheels 44 may be positioned in a width direction of the robot 40 as a width, and sets a maximum distance of positions at which the wheels 44 may be positioned in a length direction of the robot 40 as a length, by using the relative positions of the joints 45 with respect to the center of the robot 40, the relative positions of the centers of the wheels 44 with respect to the corresponding joints 45, the radii of the wheels 44, and the steering angles θ1 and θ2 of the corner modules 46.

In another example, as illustrated in FIG. 4b, if the robot 40 has the variable corner module 46 and the wheels 44 are in the extended positions, the robot boundary calculator 26 may determine a rectangle as the robot boundary 48, which sets a maximum distance in the width direction of the robot 40 at which the wheels 44 may be positioned as the width, and sets a maximum distance in the length direction of the robot 40 at which the wheels 44 may be positioned as the length, using the relative positions of the joints 45 with respect to the center of the robot 40, the relative positions of the centers of the wheels 44 with respect to the corresponding joints 45, the radii of the wheels 44, the steering angles θ1 and θ2 of the corner modules 46, and the longitudinal distances L1 and L2 from the centers of the wheels to the corresponding joints.

However, a method for determining the robot boundary 48 is not limited to the method described above. For example, if the robot 40 has the fixed shape, the robot boundary 48 may be determined under the maximum steering angle of the corner module 46, and if the robot 40 has the variable corner module 46, the robot boundary 48 may be determined under the maximum longitudinal distance from the center of the wheel 44 to the joint and the maximum steering angle of the variable corner module 46.

The circle approximation device 28 may be configured to model the area of the robot 40 as four relatively small circles o1, o2, o3, and o4 and three relatively large circles o5, o6, and o7 using the robot boundary 48 determined in the robot boundary calculator 26.

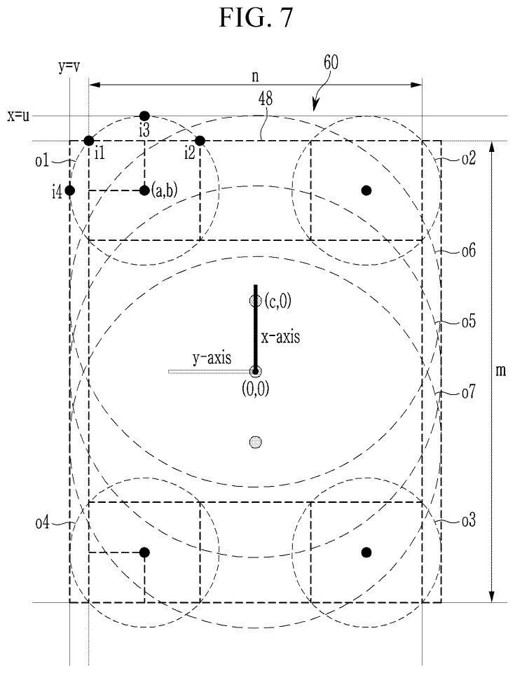

FIG. 7 illustrates a schematic diagram for describing a method for modeling a rectangular area of a robot with a certain number of circles. As illustrated in FIG. 7, the robot boundary 48 determined by the robot boundary calculator 26 may have a length of m and a width of n, and for convenience of description, it is assumed that the center of the robot boundary 48 is positioned at an origin (0, 0), the x-axis corresponds to the length direction (an upper side in the drawing is a positive value), and the y-axis corresponds to the width direction (a left side in the drawing is a positive value).

The circle approximation device 28 may first determine parameters of four small circles o1, o2, o3, and o4 positioned at four corners of the robot boundary 48. Herein, the parameters of the small circles o1, o2, o3, and o4 may include center coordinates (a, b) and a radius r1 of the small circles. This specification briefly describes determining the parameters of the small circle o1 at an upper left side.

An equation of the small circle o1 at the upper left side is Equation 1.

$${( x - a )}^{2} + {( y - b )}^{2} = r {1}^{2} \qquad [ Equation 1 ]$$

The small circle o1 at the upper left side may pass through an upper left vertex i1, and a point i2 closest to the upper left vertex i1 among points that divide the upper short side into three equal or substantially equal portions. In addition, assuming that the small circle o1 at the upper left side is tangent to two lines x=u and y=v, the small circle o1 at the upper left side may pass through a point i3 tangent to x=u and a point i4 tangent to y=v. In this case, the coordinates of i1 to i4 are, in one exemplary implementation, as follows.
i1(m/2, n/2), i2(m/2, n/6), i3(u, b), and i4(a, v)

In addition, the radius r1 of the small circle o1 at the upper left side is as in Equation 2.

$$r 1 = u - a = v - b \qquad [ Equation 2 ]$$

By substituting the coordinates of i1 to i4 and Equation 2 into Equation 1, the center coordinates (a, b) and the radius r1 of the small circle o1 at the upper left side may be determined.

Similarly, the circle approximation device 28 may determine the parameters of the small circle o2 at the upper right side, the small circle o3 at the lower right side, and the small circle o4 at the lower left side.

Thereafter, the circle approximation device 28 may determine parameters of three large circles o5, o6, and o7 positioned in a central portion of the robot boundary 48. Herein, the parameters of three large circles o5, o6, and o7 may include center coordinates and a radius r2 of the large circles.

The large circle o5 positioned at a center of the robot boundary 48 has a center at (0,0) and its radius r2 is v. Furthermore, if the center coordinate of the large circle o6 positioned in an upper central portion is (c,0), c may be determined as in Equation 3.

$$r 2 = v = u - c \qquad [ Equation 3 ]$$

In this case, the center coordinate of the large circle o7 positioned at a lower central portion may become (−c, 0).

As described above, when the circle approximation device 28 may model the robot boundary 48 as the four small circles o1, o2, o3, and o4 and the three large circles o5, o6, and o7, the collision detector 30 may be configured to receive information about robot area modeling 60 from the circle approximation device 28, receive information about the cost map 54 from the cost map creator 24, and determine whether the robot area modeling 60 collides with the obstacle using the robot area modeling 60 and the cost map 54.

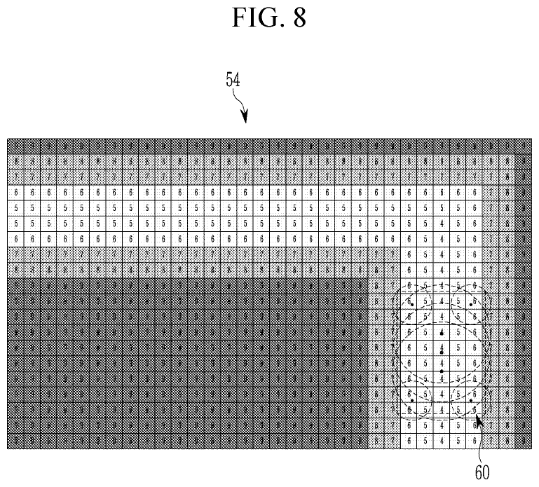

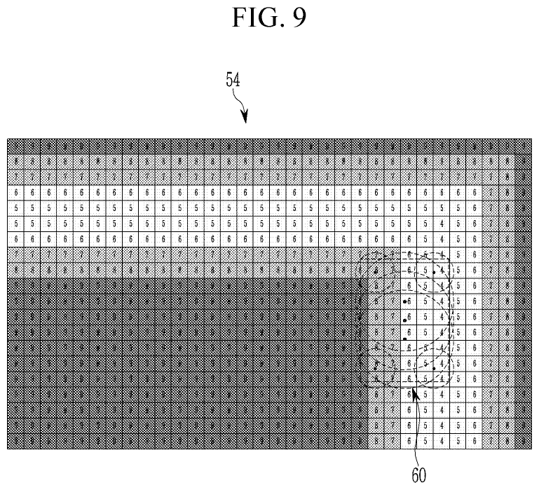

FIG. 8 illustrates a schematic diagram of a method of determining a collision using a robot area modeled with a certain number of circles, showing a case where a robot does not collide with an obstacle, and FIG. 9 illustrates a schematic diagram of a method for determining a collision using a robot area modeled with a certain number of circles, showing a case where a robot collides with an obstacle.

For example, as illustrated in FIG. 8, the collision detector 30 may determine a risk of collision with the obstacle for each of four small circles o1, o2, o3, and o4 and three large circles o5, o6, and o7, and if none of the circles has the risk of collision with the obstacle, may determine that the robot area modeling 60 does not collide with the obstacle. In contrast, as shown in FIG. 9, if any one of the four small circles o1, o2, o3, and o4 and the three large circles o5, o6, and o7 has a risk of colliding with the obstacle (two small circles and three large circles on the left side in FIG. 9 are determined to collide with the obstacle), the collision detector 30 may determine that the robot area modeling 60 collides with the obstacle. Herein, a method for determining whether each circle collides with an obstacle is not specifically restricted, and various methods known to those skilled in the art may be employed. For example, the occupied area of the obstacle may be expanded by the radius of the circle, and whether the center of the circle is positioned within the expanded obstacle area may be used to determine whether the circle collides with the obstacle.

The path follower 32 may generate a path from a current position of the robot 40 to a destination while or otherwise in accord with avoiding the obstacle by using the information about the cost map 54, the information about the robot area modeling 60, and/or whether the robot area modeling 60 collides with the obstacle, and may control driving and steering of the robot 40 such that the robot 40 follows the generated path.

In one example, the path follower 32 may generate multiple paths based on the information about the cost map 54, may determine whether there is a risk of collision with the obstacle when the robot 40 follows the paths based on the generated paths and the information about the robot area modeling 60, and may generate a shortest path among the paths that are unlikely to collide with the obstacle as a final path.

In another example, the path follower 32 may predict a future position of the robot 40 after a preset time interval based on the current position of the robot 40 and the information about the cost map 54, the collision verifier 30 may determine whether there is a risk of collision with the obstacle based on the information about the cost map 54, the information about the robot area modeling 60, and the future position of the robot 40, and the path follower 32 may generate a path that guides the robot 40 to the future position where the robot 40 is unlikely to collide with the obstacle.

A method for generating a feasible path from the current position of the robot 40 to the destination and ensuring the robot follows the generated path is not specifically limited to the example described above, and various path generation and following methods known to those skilled in the art may be employed.

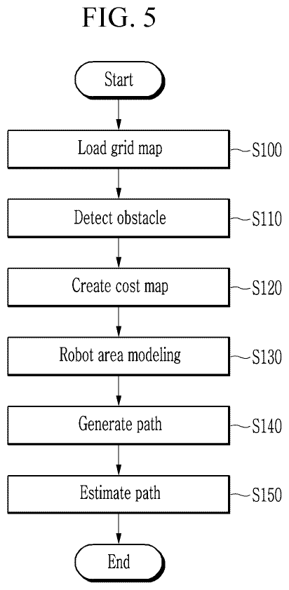

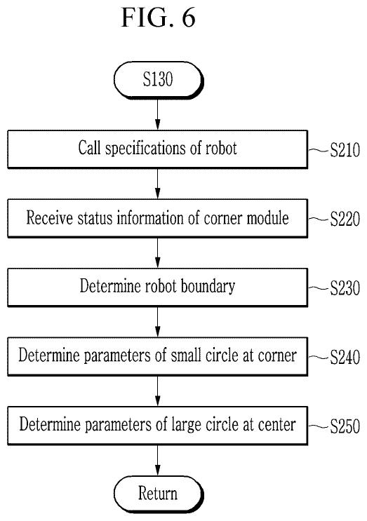

Hereinafter, a path generation method according to another embodiment of the present disclosure will be described with reference to FIGS. 5 and 6. FIG. 5 illustrates a flowchart showing a path generation method according to another embodiment of the present disclosure, and FIG. 6 illustrates a detailed flowchart of Operation S130 in FIG. 5.

As illustrated in FIG. 5, the path generation method according to another embodiment of the present disclosure may start at operation S100. To perform the operation S100, the sensor device 10 may determine the sensor data within the field of view, and may transmit the determined sensor data to the controller 20.

The cost map creator 24 may load the grid map stored in the memory of the controller 20 at the operation S100, and the obstacle detector 22 of the controller 20 may determine the obstacle based on the sensor data at operation S110. An execution order of the operations S100 and S110 is not limited to the order illustrated in FIG. 5.

When the grid map is loaded and the obstacle is determined, the cost map creator 24 may create the occupancy grid map 50 based on the grid map and the obstacle information, and may create the cost map 54 for surroundings of the robot 40 based on the occupancy grid map 50 and the obstacle information at operation S120.

Based at least in part on the creation of the cost map 54, or regardless of the creation of the cost map 54, the area of the robot 40 may be modeled with the certain number of circles at operation S130. The operation S130 will be described in more detail with reference to FIG. 6.

As shown in FIG. 6, the operation S130 may start at operation S210, and at the operation S210, the controller 20 may call the specifications of the robot 40 stored in the memory. In addition, the sensor device 10 may determine the status information of the corner module 46, and the controller 20 may receive the status information of the corner module 46 from the sensor device 10. As described above, the specifications of the robot 40 may include the relative positions of the joints 45 with respect to the center of the robot 40, the relative positions of centers of the wheels 44 with respect to the corresponding joints 45, the radii of the wheels 44, a height of the robot 40, etc., and the status information of the corner module 46 may include whether the corner module 46 serves as the variable corner module 46, the steering angles θ1 and θ2 of the corner modules 46, and/or the longitudinal distances L1 and L2 from the centers of the wheels to the corresponding joints.

When the specifications of the robot 40 are called and the status information of the corner module 46 is received, the controller 20 may determine the smallest rectangle encompassing the area of the robot 40 where the robot 40 may exist as the robot boundary 48 based on the specifications of the robot 40 and the status information of the corner module 46 at operation S230.

When the robot boundary 48 of the rectangle is determined, the controller 20 may determine the parameters of the four small circles o1, o2, o3, and o4 positioned at the four corners using the determined robot boundary 48 at operation S240. The parameters of a small circle may include the center coordinates (a, b) and the radius r1 of the small circle, and the parameters of the small circle may be determined such that the small circle passes through the vertex close to the small circle and the point that is close to the vertex among the points that divide the short side including the vertex into three equal (or substantially equal) portions. The operation S240 may be repeated until the parameters of all the four small circles o1, o2, o3, and o4 are determined.

When the parameters of the four small circles are determined, the controller 20 may determine the parameters of the three large circles o5, o6, and o7 positioned in the central portion using the parameters of the small circles and the robot boundary 48 at operation S250. The parameters of a large circle may include the center coordinates of that large circle and the radius r2 thereof. The center of the large circle in the central portion may be the center of the robot boundary 48, and the radius r2 of the large circle in the center may be determined such that the large circle in the center is tangent to a line parallel to a long side and to which a small circle is tangent. Additionally, the parameters of another large circle in the central portion may be determined such that another large circle in the central portion is tangent to two lines parallel to long and short sides and to which a small circle is tangent.

Referring again to FIG. 5, when the area of the robot 40 is modeled with the certain number of circles, the controller 20 may generate the feasible path from the current position of the robot 40 to the destination while or otherwise in accord with avoiding the obstacle by using the cost map 54 and the robot area modeling 60 at operation S140, and may control the driving and steering of the robot 40 to follow the generated path at operation S150.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

What is claimed is:

1. A method for modeling an area of a robot including at least one wheel,
the method comprising:
determining status information of a corner module of the robot by a sensor device;
receiving the status information of the corner module by a controller;
determining a robot boundary based on specifications of the robot and the status information of the corner module by the controller; and
performing modeling with the multiple circles covering the robot boundary by the controller,
wherein the robot boundary has a smallest rectangle that encompasses the area of the robot in which the robot is locatable,
wherein performing modeling with the multiple circles covering the robot boundary includes:
performing modeling with multiple small circles, each of which is positioned at a corner and has a first radius; and
performing modeling with multiple large circles, each of which is positioned at a central portion and has a second radius that is greater than the first radius.

2. The method of claim 1, wherein:
a number of small circles is four, and a number of large circles is three.

3. The method of claim 2, wherein:
performing modeling with multiple small circles includes determining parameters of four small circles,
parameters of each small circle include center coordinates of each small circle and a first radius, and
the parameters of each small circle are determined such that each small circle passes through a vertex close to the corresponding small circle and a point that is close to the vertex among points that divide a short side of the robot boundary including the vertex into three equal portions.

4. The method of claim 3, wherein:
performing modeling with multiple large circles includes determining parameters of three large circles;
parameters of each large circle include center coordinates of each large circle and a second radius;
the three large circles include a large circle at a center, and a center of the large circle at the center coincides with a center of the robot boundary; and
the second radius is determined such that the large circle at the center is tangent to a line parallel to a long side of the robot boundary and to which the small circle is tangent.

5. The method of claim 4, wherein:
a center of each of the remaining large circles is determined to be tangent to two lines parallel to long and short sides of the robot boundary and to which a small circle is tangent.

6. The method of claim 1, wherein:
the status information of the corner module includes whether the corner module is a selected one or more of a variable corner module, a steering angle of the corner module, or a longitudinal distance from a center of the wheel to a corresponding joint.

7. The method of claim 6, wherein:
the robot boundary is determined based at least in part on using a relative position of the joint to a center of the robot, a relative position of the center of the wheel to the corresponding joint, a radius of the wheel, and the steering angle of the corner module, based at least in part on the status information of the corner module indicates that the corner module is not the variable corner module.

8. The method of claim 6, wherein:
the robot boundary is determined based at least in part on using a relative position of the joint to a center of the robot, a relative position of the center of the wheel to the corresponding joint, a radius of the wheel, the steering angle of the corner module, and the longitudinal distance from the center of the wheel to the corresponding joint, based at least in part on the status information of the corner module indicates that the corner module is the variable corner module.

9. A path generation system for a robot including at least one wheel, the system comprising:
a sensor device configured to determine sensor data within a field of view and determine status information of a corner module of the robot; and
a controller configured to:
receive the sensor data and the status information of the corner module from the sensor device;
generate a path from a current position of the robot to a destination, and control movement of the robot according to the generated path;
create a cost map corresponding to at least surroundings of the robot based on a grid map and the sensor data received from the sensor device;
model an area of the robot in which the robot is locatable with a robot area modeling;
generate a feasible path from the current position of the robot to the destination in accordance with avoiding an obstacle by using the cost map and the robot area modeling; and
control driving and steering of the robot to follow the generated path,
wherein the robot area modeling includes multiple circles covering a robot boundary, and the robot boundary has a smallest rectangle that encompasses the area of the robot in which the robot is locatable.

10. The path generation system of claim 9, wherein:
the controller, based at least in part on modeling with the robot area modeling, is configured to determine the robot boundary based on specifications of the robot and the status information of the corner module, and
wherein the controller is configured to model the robot boundary with four small circles, each of which is positioned at a corner and has a first radius, and three large circles, each of which is positioned at a central portion and has a second radius that is greater than the first radius.

11. The path generation system of claim 10, wherein:
the controller, based at least in part on modeling with the four small circles, is configured to determine parameters of the four small circles;
the parameters of each small circle include center coordinates of each small circle and a first radius; and
the parameters of each small circle are determined such that each small circle passes through a vertex close to the corresponding small circle and a point that is close to the vertex among points that divide a short side of the robot boundary including the vertex into three substantially equal portions.

12. The path generation system of claim 11, wherein:
the controller, based at least in part on modeling with the three large circles, is configured to determine parameters of the three large circles;
the parameters of each large circle include center coordinates of each large circle and a second radius;
the three large circles include a large circle at a center, and a center of the large circle at the center coincides with a center of the robot boundary; and
the second radius is determined such that the large circle at the center is tangent to a line parallel to a long side of the robot boundary and to which the small circle is tangent.

13. The path generation system of claim 12, wherein:
the controller is configured to determine a center of each of remaining large circles to be tangent to two lines parallel to long and short sides of the robot boundary and to which a small circle is tangent.

14. The path generation system of claim 9, wherein:
the status information of the corner module includes whether the corner module is a selected one or more of a variable corner module, a steering angle of the corner module, or a longitudinal distance from a center of the wheel to a corresponding joint.

15. A path generation method for a robot,, the method comprising:
determining sensor data and status information of a corner module of the robot within a field of view by a sensor device;
receiving the sensor data and the status information of the corner module by a controller;
creating a cost map corresponding to at least surroundings of the robot based on a grid map and the sensor data received from the sensor device by the controller;
modeling an area of the robot in which the robot is locatable with a robot area modeling by the controller;
generating a path from a current position of the robot to a destination in accord with avoiding an obstacle by using the cost map and the robot area modeling by the controller; and
controlling driving and steering of the robot to follow the generated path by the controller,
wherein the robot area modeling includes multiple circles covering a robot boundary, and the robot boundary has a smallest bounding rectangle for the area of the robot.

16. The path generation method of claim 15, wherein the modeling with a robot area modeling includes:
determining the robot boundary based on specifications of the robot and the status information of the corner module;
modeling the robot boundary with four small circles, each of which is positioned at a corner and has a first radius; and
modeling the robot boundary with three large circles, each of which is positioned at a central portion and has a second radius that is greater than the first radius.

17. The path generation method of claim 16, wherein:
the modeling with four small circles includes determining parameters of the four small circles;
the parameters of each small circle include center coordinates of each small circle and a first radius; and
the parameters of each small circle are determined such that each small circle passes through a vertex close to the corresponding small circle and a point that is close to the vertex among points that divide a short side of the robot boundary including the vertex into three equal portions.

18. The path generation method of claim 17, wherein:
the modeling with three large circles includes determining parameters of the three large circles;
the parameters of each large circle include center coordinates of each large circle and a second radius;
the three large circles include a large circle at a center, and a center of the large circle at the center coincides with a center of the robot boundary; and
the second radius is determined such that the large circle at the center is tangent to a line parallel to a long side of the robot boundary and to which the small circle is tangent.

19. The path generation method of claim 18, wherein:
a center of each of the remaining large circles is determined to be tangent to two lines parallel to long and short sides of the robot boundary and to which a small circle is tangent.

20. The path generation method of claim 15, wherein:
the status information of the corner module includes whether the corner module is a selected one or more of a variable corner module, a steering angle of the corner module, or a longitudinal distance from a center of the wheel to a corresponding joint.
